(19) United States
(12) Patent Application Publication
(10) Pub. No.: US 2005/0238546 A1
(43) Pub. Date: Oct. 27, 2005

(54) Canister for an oxygen generation cell

(76) Inventors: Keith J. Holmes, Janesville, WI (US); Miranda F. Lynch, Janesville, WI (US); Matthew L. Holmes, Janesville, WI (US)

Correspondence Address: MICHAEL BEST & FRIEDRICH, LLP, 100 E WISCONSIN AVENUE, MILWAUKEE, WI, 53202, US

(21) Appl. No.: 10/831,743

(22) Filed: Apr. 23, 2004

(51) Int. Cl. A62B 7/08

(52) U.S. Cl. 422/120

(57) ABSTRACT

A canister for use with a chemical oxygen generation cell. In some embodiments, the canister includes two main canister assemblies. One assembly houses the briquette, the ignition cone, and one or more filters. A second assembly houses a thimble and one or more filters. Once the components are placed within each assembly, the two assemblies can then be easily joined together to form the cell. In some embodiments, the sealed canister is constructed with at least one weakened area along at least one canister wall. Upon premature activation of the cell, pressure within the sealed canister causes at least one controlled rupture in the weakened area of the canister to vent gases and prevent an explosion.

### BACKGROUND

Chemical oxygen generators are used in some situations to deliver copious quantities of oxygen at a controlled rate. The oxygen produced by the generator can be medically pure for direct human inhalation in some circumstances. Conventional generators generally have a chlorate candle contained within a soft-soldered tin-plated steel can.

Although it is desirable for the cell to remain completely inert until intentionally activated, some cells can ignite prematurely. In some situations involving premature ignition, oxygen produced by the candle cannot vent from the canister. For example, if the seal on the canister is not punctured, gas will not be able to vent from the canister as intended, and pressure can build within the cell. Generally one of the soft-soldered seams of the can ruptures to allow the oxygen to vent.

### SUMMARY OF THE INVENTION

Some embodiments of the invention are directed to a canister for use with a chemical oxygen generation cell. In some embodiments, the canister is constructed to increase the shelf life of the cell by providing a canister that can be sealed better than conventional cans, which makes it less likely that materials can enter the cell to partially react the cell, cause premature ignition, or deterioration.

If premature ignition does occur, some embodiments of the canister have weakened wall sections to allow controlled ruptures of the wall to exhaust the oxygen generated by premature ignition.

In some embodiments, the canister comprises two main canister assemblies. One assembly houses a briquette, an ignition cone, and one or more filters. A second assembly houses a thimble and one or more filters. Once the components are placed within each assembly, the two assemblies can be easily joined together to form the cell.

Some embodiments are directed towards a sealed chemical oxygen generation canister adapted to prevent uncontrolled explosion of the canister due to premature ignition of an oxygen generation briquette within the sealed canister. The canister includes at least one sidewall having a first end and a second end and a first and second end wall sealed to opposite ends of the sidewall. At least one of the sidewall and the end walls has a weakened area relative to the remainder of the wall. The weakened area is adapted to rupture and form an aperture in response to internal pressure within the canister exceeding a predetermined threshold level during premature ignition of the cell.

Some embodiments are directed towards a chemical oxygen generation cell having an inert state in which oxygen is not generated and an activated state in which oxygen is generated. The chemical oxygen generation cell having a canister with a plurality of walls. At least one of the plurality of walls has a weakened area relative to the remainder of the wall. The canister has a sealed state preventing materials from entering or leaving canister. An oxygen generating briquette is located within the canister. Generation of oxygen by the briquette while the canister is in the sealed state causes pressure to increase within the canister and rupture the weakened area of the at least one of a plurality of walls, which vents oxygen from the canister.

Some embodiments are directed towards a canister of an oxygen generation cell, wherein the oxygen generation cell has an oxygen generating briquette, an ignition material adjacent the briquette, and a plurality of filters to filter the generated oxygen. The canister includes a housing assembly adapted to contain the briquette and the ignition material adjacent the briquette. The housing assembly includes a sidewall and an end wall coupled to the sidewall. A top cover assembly is coupled to the housing to seal the canister. The top cover assembly includes a cover, a filter housing coupled to the cover to define a first subassembly of the top cover assembly and having a plurality of detents to retain a filter, a thimble subassembly coupled to the cover of the first subassembly and having a plunger slidably received within a thimble housing, and a top seal subassembly coupled to the cover of the first subassembly and positioned over the thimble subassembly. The top seal subassembly includes a seal and a body holding the seal. Each subassembly is assembled prior to being coupled to the other subassemblies and each assembly is assembled prior to being coupled to the other assembly.

Some embodiments are directed towards a method of assembling an oxygen generation cell. The method includes the acts of inserting a briquette into a generator housing and inserting an ignition material into the housing adjacent the briquette. A top cover assembly is assembled by coupling a thimble housing to a filter housing, placing a filter into the filter housing, and securing the filter within the filter housing. The assembled top cover assembly is coupled to the generator housing.

Some embodiments are directed towards a method of preventing an uncontrolled explosion of a prematurely ignited oxygen generation cell. The method includes providing a prematurely ignited oxygen generation cell having an initially sealed canister that prevents materials from entering or leaving the canister. Oxygen is released from a briquette positioned within the canister in response to the premature ignition and the pressure within the sealed canister increases due to oxygen being released. A predetermined portion of the canister is ruptured in a controlled manner when the pressure within the canister exceeds a predetermined threshold level.

Some embodiments are directed towards an oxygen generator cell having a increased shelf-life. The cell includes a sealed canister having a stainless steel housing sealably welded to a stainless steel cover to prevent materials from entering or leaving canister. A thimble depends from the cover of the can and a plunger is adapted to slide within the thimble and confine a fluid between the plunger and the thimble. A projection depends from the plunger and is adapted to pierce the bottom of the thimble when the plunger is depressed to allow the fluid to exit the thimble through the pierced end. An oxygen generating briquette is located within the canister and ignition material on one end of the briquette is adapted to be ignited by fluid received from the pierced thimble.

Further aspects of the present invention, together with the organization and operation thereof, will become apparent from the following detailed description of the invention when taken in conjunction with the accompanying drawings.

### BRIEF DESCRIPTION OF THE DRAWINGS

FIG. 1 is a cross-sectional view of a chemical oxygen generation cell comprising aspects of the invention;

FIG. 2 is an exploded, cross-sectional view of the chemical oxygen generation cell illustrated in FIG. 1, showing two assemblies of the cell;

FIG. 3 is an exploded, cross-sectional view of the briquette housing assembly illustrated in FIG. 2;

FIG. 4 is an enlarged, partial cross-sectional view showing the area below line 4-4 of FIG. 3, illustrating the weakened portions of the base;

FIG. 5 is a partially exploded, cross-sectional view of the filter housing assembly illustrated in FIG. 2;

FIG. 6 is an exploded, cross-sectional view of the filter housing assembly illustrated in FIG. 5 with more components separated from each other;

FIG. 7 is a fully exploded, cross-sectional view of the filter housing assembly illustrated in FIGS. 5 and 6;

FIG. 8 is an enlarged, partial cross-sectional view of the cover to the filter housing assembly taken along area 8-8;

FIG. 9 is a cross-sectional view of a top seal holder;

FIG. 10 is a side, cross-sectional view of a thimble;

FIG. 11 is a top view of the thimble shown in FIG. 10; and

FIG. 12 is an enlarged, partial cross-sectional view of the thimble shown in FIG. 10 showing the area defined by line 12-12.

### BRIEF DESCRIPTION OF THE PREFERRED EMBODIMENT

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

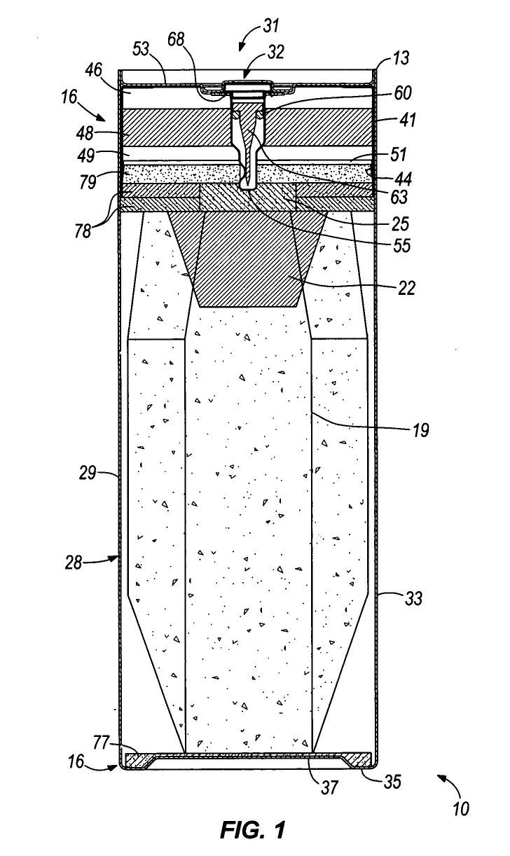

FIG. 1 illustrates a cross-sectional view of an oxygen generator cell 10 embodying one or more aspects of the present invention. The cell 10 includes a cylindrical can or canister 13 containing a plurality of filters 16, an oxygen generation briquette or chlorate candle 19, an ignition cone 22, and one or more ignition materials 25. The canister 13 can be constructed of many materials, such as tin, aluminum, stainless steel, and the like, or combinations thereof, such as, for example, tin-coated steel.

The canister 13 illustrated in FIG. 1 comprises two main assemblies; a briquette housing assembly 28 and a filter housing or top cover assembly 31. As will be described in greater detail below, each assembly can be separately constructed and subsequently joined together to simplify the assembly of the cell 10.

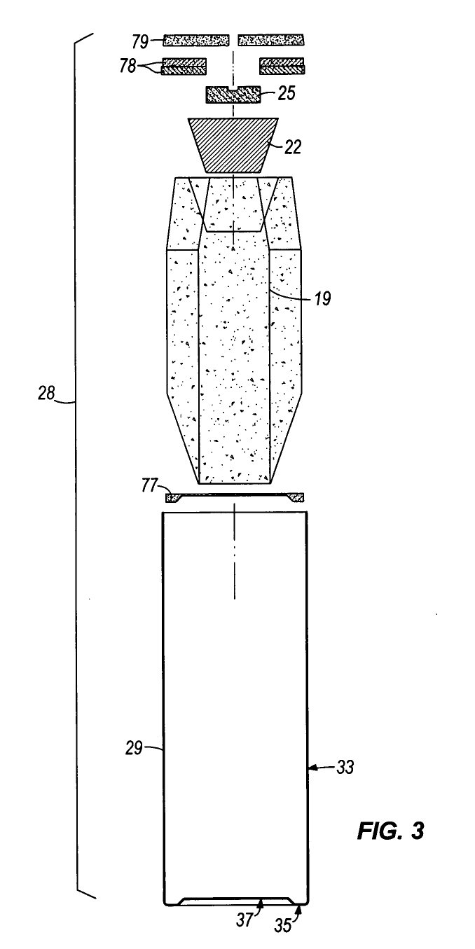

As illustrated in FIGS. 1-3, the briquette housing assembly 28 is designed to receive and house the briquette 19. Assembly 28 can also house one or more filters 16 as well as the ignition cone 22 and first fire material 25.

The filter housing assembly 31 is designed to receive and hold one or more filters 16. Furthermore, other components, such as a thimble subassembly 32 can be coupled to the filter housing assembly 31.

The briquette housing assembly 28 comprises a briquette housing 29 having a cylindrical sidewall 33 coupled to a circular bottom 35. The circular bottom 35 can have a recessed portion 37 as illustrated in FIGS. 1-4. The bottom 35 can be integrally formed with the sidewall 33 as illustrated. However, in other embodiments, the bottom 35 is formed separate from the sidewall 33 and joined in a secondary operation. In some embodiments, all seams on and between the sidewall 33 and the bottom 35 are sealed to prevent air, water, and other materials from entering or leaving the can 13 along the seam once the can 13 is assembled. The seams can be sealed in some constructions via one or more welds, soldering, adhesive, bonding, and the like.

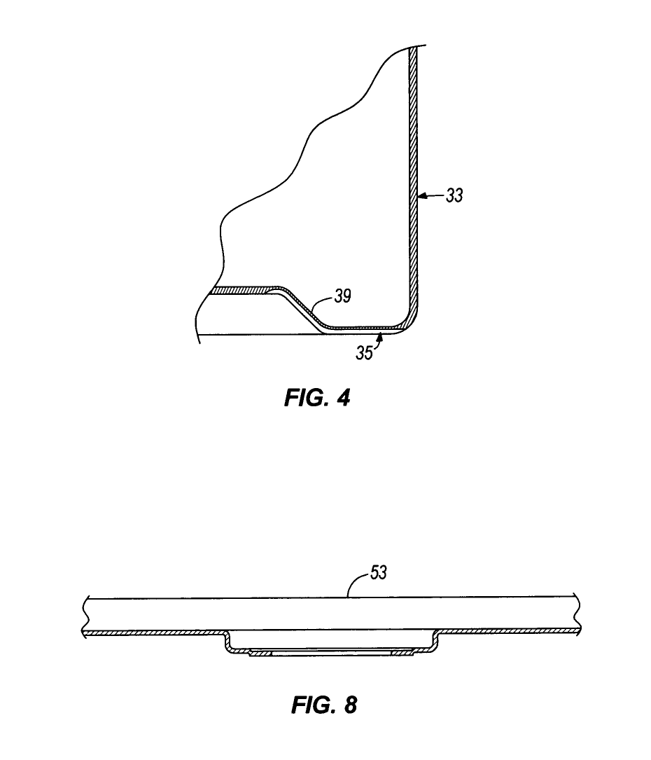

As illustrated in FIG. 4, the walls 33 or 35 of the briquette housing 29 can be designed to have one or more weakened portions 39. The weakened portions can be designed to rupture in response to an increase in pressure within a sealed canister 13 due to premature ignition. The rupture relieves the pressure by venting gases generated within the canister 13. In some constructions, the weakened portions 39 comprise intentionally thin wall constructions over a limited area. For example, the normal wall thickness of the can 13 may be about 0.015 inches, while the weakened portion may be about 0.007 or 0.008 inches, as illustrated in FIG. 4. A press can be used to thin out portions of the wall of the briquette housing 29 relative to the remainder of the wall. In other constructions, the wall is scored in a particular area to cause the weakened area 39. Note that the depth of the score or the amount of thinning is determined in part by the normal wall thickness and the predetermined pressure in which the weakened portion should rupture. In some embodiments, the weakened portion is designed to rupture at pressures greater than about 400 p.s.i. In other embodiments, the weakened portion is designed to rupture at pressures less than about 800 p.s.i. Some embodiments can be designed to prevent ruptures until pressures exceed about 1000 p.s.i.

In alternative embodiments, the walls of the canister can be formed from a first material, such as stainless steel, and at least a portion of one of the walls can be made of a second material that is weaker than the first material. Since the second material is weaker than the first material, the second material can rupture at a predetermined pressure if the cell were to ingite prematurely. The type of material used as the second material can depend upon the desired pressure in which the controlled rupture should occur (e.g., the higher the desired pressure, the stronger the material). The second material can be joined to the wall in many ways. For example, it can be welded, bonded, adhered, fastened, and the like.

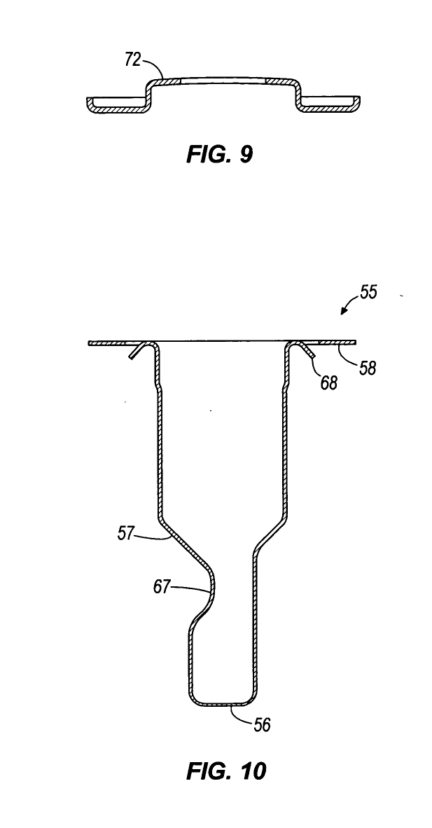

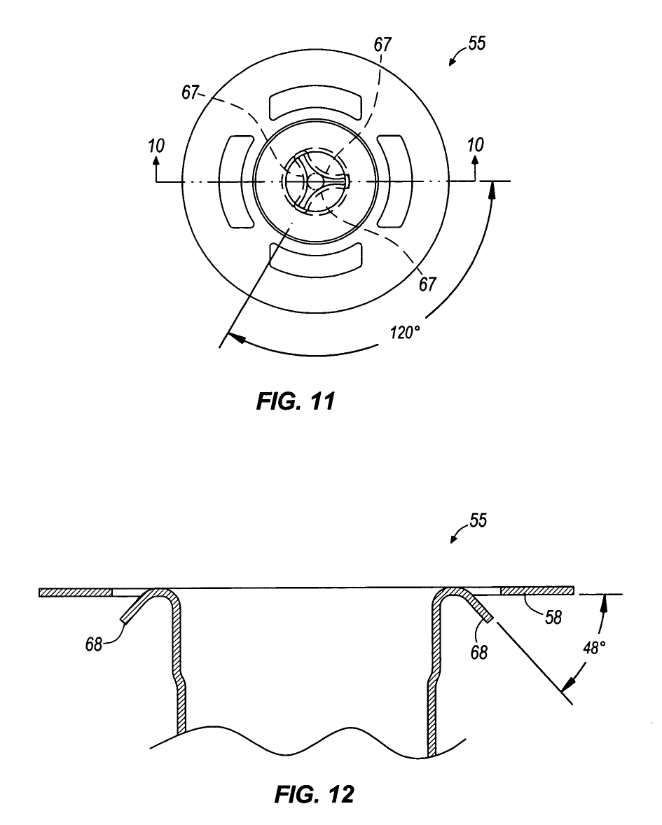

As mentioned above, the canister 13 also comprises a filter housing assembly 31 as illustrated in FIGS. 1, 2, and 5-12. The filter housing assembly 31 comprises a filter housing or assembly ring 41. The filter housing 41 is designed to receive and retain one or more filters 16 prior to assembling the filter housing assembly 31 with the briquette housing assembly 28. The illustrated filter housing 41 has a generally circular, ring-like shape dimensioned to be received within the briquette housing 29. The filter housing 41 has a plurality of detents, tongues, or projections 44 that extend toward the interior of the housing 41. These detents 44 help to retain the filters 46, 49 within the housing 41 by trapping the filters 46, 49 between the detent 44 and a top rim of the housing 41. The detents 44 can be formed and/or constructed many different ways. For example, the detents 44 can be cut or punched out of the side wall of the housing 41. In other constructions, the above mentioned elements can be retained within the housing by detent members via staking and/or curling. For example, the open end of the housing 41 can be punched, pressed, or folded to retain one or more elements within the housing 41. Furthermore, the detents 44 can extend from only portions of the periphery of the housing, as illustrated, or they can extend around the entire periphery.

In the illustrated construction, a first filter 46 is positioned within the housing 41 adjacent the top rim of the housing 41. An odor absorbent or masking material 48 is positioned adjacent the first filter 46. This material is generally granular. A second filter 49 is positioned adjacent the odor absorbent or masking material 48. This second filter helps to retain the odor absorbent or masking material 48 within the housing, especially if the odor absorbent or masking material has a granular form. Finally, the illustrated embodiment has a filter support 51 positioned adjacent the second filter 49. The filter support can be somewhat rigid relative to the filters. The filter support 51 is also adjacent the detents 44, which retain the filter support 51 and the filters within the filter housing 41.

As illustrated in the figures, a cover 53 is also coupled to the filter housing 41. The cover 53 of the illustrated embodiment is dimensioned to fit within the briquette housing 29. However, in other embodiments, the cover 53 can be dimensioned to overlap or abut the edges of the briquette housing 29. In some embodiments, the cover 53 is placed in sealing engagement with the briquette housing 29 during assembly of the cell 10. Specifically, the cover 53 can be welded to the briquette housing 29 to prevent ingress and egress of materials while the cell 10 is inert. Although the illustrated construction shows the cover 53 being separately joined to the filter housing 41, in some constructions the cover can be integrally formed with the housing 41. In some embodiments, the cover is formed from stainless steel and is spot-welded to the filter housing 41. The use of stainless steel can increase the shelf-life of the canister by preventing rust from unintentionally weakening the canister 13.

Similar to the walls of the briquette housing 29, the cover can have portions that are intentionally weakened and adapted to rupture due to increased internal pressure achieved during premature activation of the cell. The weakened portions can be intentionally thinned sections relative to the remainder of the wall, scored areas of the cover, and the like.

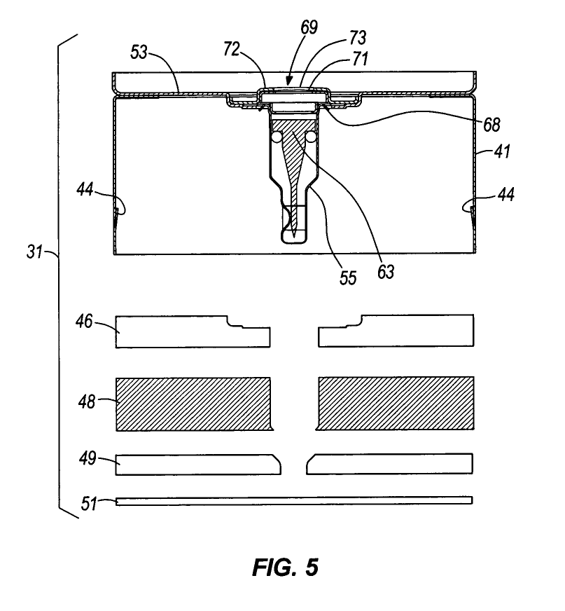

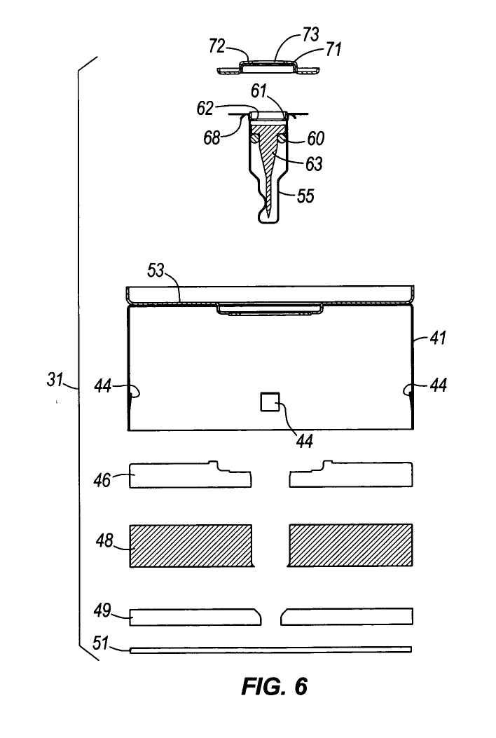

As best shown in FIGS. 5 and 6, the cover has a depending thimble 55. Although the thimble can be integrally formed with the cover 53, the illustrated construction shows the thimble 55 as being separately joined to the cover 53. Specifically, the thimble 55 is joined to cover 53 as part of a thimble subassembly, which is discussed in greater detail below.

The cover 53 has a central circular aperture dimensioned to receive the thimble 55. The thimble 55 is positioned within the aperture and coupled to cover 53. In some constructions, the thimble 55 or thimble subassembly is push fit within a recess of the cover 53 and the interface between the cover and thimble is radially laser welded. However, in other constructions, the thimble 55 can be coupled to the cover many other ways, such as by bonding, adhering, and the like.

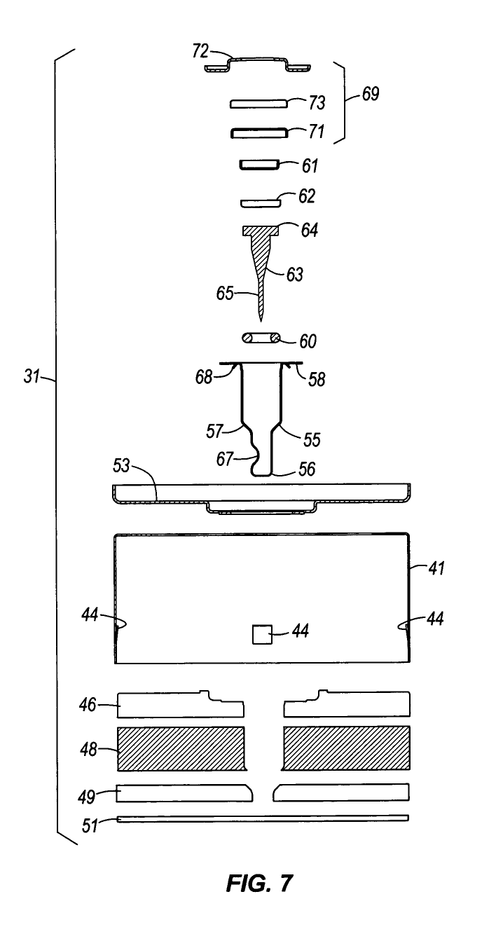

Referring to FIG. 7, the thimble 55 has a reduced diameter, leading nose 56 and an outwardly flared collar portion 57 terminating in a flat outturned flange 58. The thimble 55 and its nose 46 are filled with a fluid such as water and the water is at least partially trapped therein by an O-ring seal 60 and a plunger 63. The thimble assembly also has a seal positioned adjacent the plunger 63 to seal-off and contain the water within the thimble. The seal includes a seal ring 61 having a sealing shim 62. The seal ring 61 and shim 62 are positioned within and joined to the open end of the thimble 55. The seal ring 61 and shim 62 can be joined to the thimble 55 by an interference fit, radial laser welds, solder, adhesive, bonding, frictional welding, and the like.

The seal shim 62 is punctured to actuate the plunger 63. The plunger 63 is slidable within the thimble 55 and has a boss portion 64 surrounded by or adjacent to the O-ring seal 60. A piercing member or pin 65 extends from this boss portion 64 into the reduced diameter nose portion 56. Depressed portions 67 in the nose 56 provide a guide for the piercing member 65 and confines it in the center of the nose 56. The thimble 55 also has one or more vents 68 positioned along the flange 58 of the thimble 55. When the cell is intentionally activated, oxygen can vent from the canister through the vents 68.

As discussed above, the thimble 55 can be one component of a thimble subassembly as shown in FIG. 6. Specifically, the thimble subassembly can include the thimble 55, the plunger 63, the o-ring 60, the seal ring 61, and the seal shim 62. All of these components can be assembled into the thimble subassembly shown in FIG. 6, and then the thimble subassembly can be connected to the filter housing assembly 31.

The thimble subassembly can be assembled as follows. The thimble 55 can be filled with a fluid such as water and the o-ring 60 and plunger 63 can be inserted within the open end of the thimble 55. Next, the water can be sealed within the thimble by adding a seal ring 61 having a seal shim 62. The seal ring 61 and seal shim 62 can be radially laser welded to the thimble 55. The entire assembly can then be used to assemble the filter housing assembly 31. Specifically, the thimble assembly can be inserted into an aperture of the cover 53 and coupled to the cover 53. In the illustrated embodiment, the flange of the thimble assembly is radially laser welded to the cover.

As illustrated in FIGS. 1, 2, and 5-7, a second seal 69 can be positioned over the thimble 55 to prevent unintentional activation of the cell 10 and prevent materials from entering or leaving the canister via the vents 68 in the flange 58 of the thimble 55. Specifically, the seal 69 can comprise one or more components, such as the seal ring 71, seal holder 72, and seal shim 73 illustrated in the figures. These components can be assembled as subassembly of the filter housing assembly 31. The top seal shim 73 and the top seal ring 71 can be placed within the top seal holder 72. These three component can be welded, bonded, soldered, adhered, and the like to form the top seal subassembly. The top seal subassembly can then be connected to the cover 53 (by a radial laser weld, for example) and form part of the filter housing assembly 31. As illustrated, the top seal subassembly is not connected to the cover 53 until the thimble subassembly is connected to the cover 53.

The top seal subassembly is dimensioned to seal the opening of the thimble 55 as well as the vents 68 located in the flange 58 of the thimble. Once the canister is fully assembled, this seal subassembly prevents items from entering and leaving the canister via the only opening in the can 13 (i.e., the vents 68). The seal shim 73 is punctured to intentionally actuate the cell 10. Once the top seal shim 73 and the thimble seal shim 62 are punctured, the plunger 63 can be moved within the thimble 55 to cause the projecting pin 65 to pierce the bottom wall of the thimble 55 and eject the fluid (e.g., water) through the pierced opening. As will be explained in greater detail below, the water will start a reaction with the first fire or ignition material 25, which will ultimately lead to oxygen generation within the cell 10.

As mentioned above, the cell 10 contains an oxygen generating briquette or chlorate candle 19. Although the briquette can have a variety of constructions, in some embodiments the briquette 19 comprises a compressed briquette of an alkali metal chlorate, such as sodium chlorate, and a sufficient amount of a catalyst, such as sodium or potassium oxide, to maintain a self-sustaining catalytic decomposition reaction which will liberate oxygen from the chlorate without any additional heat or added fuel. The briquette can have an elongated, tapered body as illustrated. The shape of the briquette and the relative sizes of the various portions thereof can be carefully controlled so that a constant delivery rate of oxygen will be maintained from the start to the finish of the catalytic decomposition of the chlorate material. The burning cross sectional area of the candle generally widens through an annular zone from the relatively narrow rim top edge to the full hexagonal body.

A central recess or well is positioned at the top of the briquette 19. The recess of the candle or briquette 19 is filled with ignition cone material 22, which when activated will release heat of sufficient intensity to immediately activate the briquette.

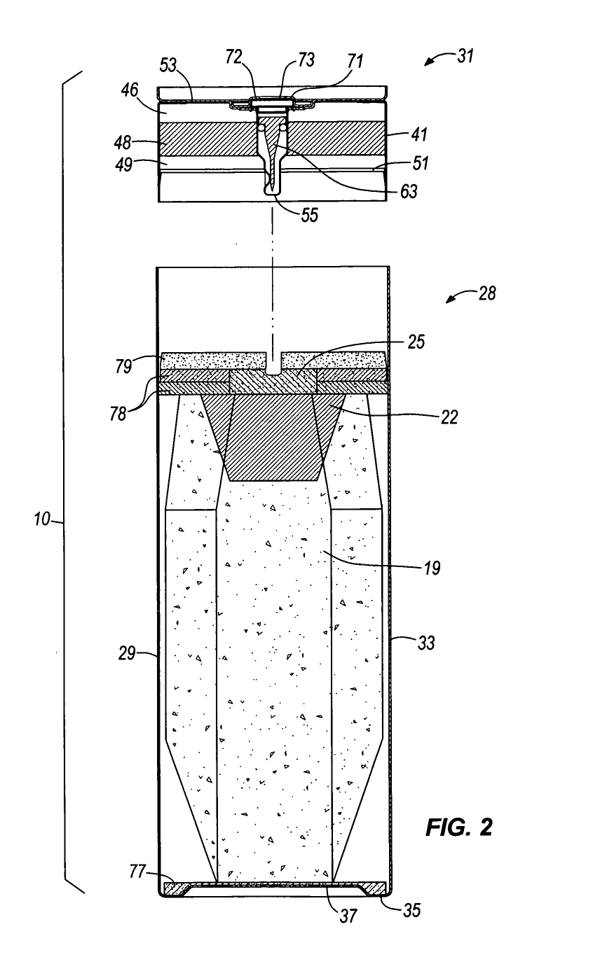

The illustrated briquette housing assembly 28 is assembled by first inserting a filter 77 into the briquette housing 29. The filter can be positioned adjacent the recessed base of the housing 29. Next, the briquette 19 can be inserted into the housing 29 and placed adjacent the filter 77. The ignition cone 22 can then be placed within a recess of the briquette 19 if it was not previously inserted with the briquette 19. One or more additional filters 78 can then be positioned within the housing adjacent the briquette 19 and ignition cone 22. Furthermore, an ignition material or first fire 25 can be inserted into the housing 29 and positioned adjacent the ignition cone 22. Finally, as shown in FIG. 2, yet another filter 79 can be inserted into the housing 29 and positioned adjacent the previous filters 78 and the first fire 25.

The illustrated filter housing assembly 28 can be assembled component by component, or it can be assembled using several subassemblies. The illustrated embodiments comprise three main subassemblies: a top cover/filter housing subassembly, a thimble subassembly, and a top seal subassembly. The top cover/filter housing subassembly is assembled by connecting the cover 53 with filter housing 41. The cover 53 can be spot welded to the filter housing 41.

As noted above, the thimble subassembly can be assembled as follows. The thimble 55 can be filled with a fluid such as water and the o-ring 60 and plunger 63 can be inserted within the open end of the thimble 55. Next, the water can be sealed within the thimble by adding a seal ring 61 having a seal shim 62. The thimble subassembly can then be joined to the top cover/filter housing subassembly. Specifically, the thimble assembly can be inserted into an aperture of the cover 53 and coupled to the cover 53. In the illustrated embodiment, the flange of the thimble assembly is radially laser welded to the cover.

The top seal shim 73 and the top seal ring 71 are placed within the top seal holder 72 and welded together to form the top seal subassembly. The top seal subassembly can then be positioned over the thimble subassembly on the cover 53 and connected to the cover 53 via radial laser welds.

One or more filters 16 can then be placed into the filter housing 41. Specifically, a first filter 46 is inserted into the filter housing 41. The first filter 46 is positioned to abut the upper rim of the housing 41 and to surround a portion of the thimble 55. The odor masking material 48 can then be inserted into the housing adjacent the first filter 46 and surrounding a portion of the thimble 55. A second filter 49 can be inserted into the filter housing 41 and placed adjacent the odor masking material 48. Finally, the filter support 51 can be inserted into the filter housing 41 adjacent to the second filter 49. The filter support 51 can engage the detents 44 of the filter housing 41 to help retain the filters 16 within the filter housing 41 during assembly.

Once the filter housing assembly 31 and the briquette housing assembly 28 are assembled, they can be joined to each other to form an assembled cell 10. Preferably, the two assemblies are joined in sealed relationship to prevent materials from entering or leaving the canister while the canister 13 is in an inert and inactivated state. As illustrated in FIG. 1, the filter housing assembly 31 is dimensioned to fit within the briquette housing 29. Once the filter housing assembly 31 is inserted into the briquette housing 29 the two assemblies can be welded to each other to seal the canister 13. Specifically, a radial laser weld can be used to connect and seal an interface between the two assemblies.

Since some embodiments of the cell 10 have a stainless steel canister that is laser welded along engaging parts, the canister generally will not rupture along a seam due to pressure build-up from a premature ignition. Although this construction increases the shelf life of the cell 10 by preventing potential leaks, premature ignition of the cell (i.e., without puncturing the top seal shim) can cause the cell to explode. Thus, some embodiments have canister walls comprising weakened areas 39 as discussed above. These weakened areas rupture when the pressure within the cell 10 reaches a threshold level (e.g., about 400 to about 800 psi in some embodiments). The rupture allows gas to escape the cell 10 and prevent an uncontrolled explosion.

The operation of an initially sealed and inert cell of the above construction will now be described. To activate the cell, a user will puncture the top seal shim 73 and the thimble seal shim 62 to actuate the plunger 63 within the thimble 55. By actuating the plunger 63, the projecting piercing member 65 contacts the thimble 55 and pierces a hole in the thimble 55. This allows the fluid (e.g., water) in the thimble 55 to escape and contact the ignition material or first fire 25, which causes a chemical reaction. This in turn causes a chemical reaction in the ignition cone 22, which ultimately causes a reaction in the briquette 19. As the briquette 19 reacts, oxygen is released.

However, in some instances, premature ignition may occur. In such a situation, a user does not intentionally initiate the chemical reaction. As such, the top seal shim 73 may not be pierced, which will prevent generated oxygen from exiting the canister via the vents 68 within the flange 58 of the thimble 55. As the briquette 19 reacts, oxygen is released. As oxygen is released, the pressure within the canister 13 increases because the canister 13 remains sealed. As the pressure continues to increase, forces are exerted on the canister walls. These forces initially cause the walls to elastically deform. The walls will deform the greatest at the weakened portion of the canister and the deformation can become plastic in the weakened areas 39. Ultimately, the deformation in the weakened portion 39 is so great that a wall will rupture or tear in this area, which allows gas to leave the canister 13 and the pressure to drop.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention. For example, various alternatives to the certain features and elements of the present invention are described with reference to specific embodiments of the present invention. With the exception of features, elements, and manners of operation that are mutually exclusive of or are inconsistent with each embodiment described above, it should be noted that the alternative features, elements, and manners of operation described with reference to one particular embodiment are applicable to the other embodiments.

Various features of the invention are set forth in the following claims.

1. A sealed chemical oxygen generation canister adapted to prevent uncontrolled explosion of the canister due to premature ignition of an oxygen generation briquette within the sealed canister, the canister comprising:
at least one sidewall having a first end and a second end; and
a first and second end wall sealed to opposite ends of the sidewall, at least one of the sidewall and the end walls having a weakened area relative to the remainder of the wall, the weakened area adapted to rupture and form an aperture in response to internal pressure within the canister exceeding a predetermined threshold level during premature ignition of the cell.

2. The canister of claim 1, wherein the weakened area of the wall has a first thickness and the remainder of the wall has a second thickness greater than the first thickness.

3. The canister of claim 1, wherein the weakened area of the wall is caused by scoring the wall.

4. The canister of claim 1, wherein the first end wall defines a base and the second end wall defines a top to the canister, the weakened area positioned near the middle of the top.

5. The canister of claim 1, wherein the first end wall defines a base and the second end wall defines a top to the canister, the weakened area positioned near the periphery of the base.

6. The canister of claim 1, wherein the first end wall defines a base and the second end wall defines a top to the canister, the base having a recessed portion and the weakened area positioned along the recessed portion.

7. A chemical oxygen generation cell having an inert state in which oxygen is not generated and an activated state in which oxygen is generated, the chemical oxygen generation cell comprising:
a canister having a plurality of walls, at least one of the plurality of walls having a weakened area relative to the remainder of the wall, the canister having a sealed state preventing materials from entering or leaving canister; and
an oxygen generating briquette located within the canister, generation of oxygen by the briquette while the canister is in the sealed state thereby causes pressure to increase within the canister and rupture the weakened area of the at least one of a plurality of walls to vent oxygen from the canister.

8. The oxygen generation cell of claim 7, wherein the weakened area of the wall has a first thickness and the remainder of the wall has a second thickness greater than the first thickness.

9. The oxygen generation cell of claim 7, wherein the plurality of walls comprise at least one sidewall and two end walls coupled to opposite ends of the sidewall.

10. The oxygen generation cell of claim 9, wherein the two end walls include a top and base, the weakened area being located in the top.

11. The oxygen generation cell of claim 9, wherein the two end walls include a top and base, the base having a recessed portion, the weakened area being located along the recessed portion.

12. A canister of an oxygen generation cell, wherein the oxygen generation cell has an oxygen generating briquette, an ignition material adjacent the briquette, and a plurality of filters to filter the generated oxygen, the canister comprising:
a housing assembly adapted to contain the briquette and the ignition material adjacent the briquette, the housing assembly comprising:
a sidewall; and
an end wall coupled to the sidewall; and
a top cover assembly coupled to the housing to seal the canister, the top cover assembly comprising:
a cover;
a filter housing coupled to the cover to define a first subassembly of the top cover assembly, the filter housing having a plurality of detents to retain a filter;
a thimble subassembly coupled to the cover of the first subassembly and having a plunger slidably received within a thimble housing; and
a top seal subassembly coupled to the cover of the first subassembly and positioned over the thimble subassembly, the top seal subassembly comprising a seal and a body holding the seal;
wherein each subassembly is assembled prior to being coupled to the other subassemblies and each assembly is assembled prior to being coupled to the other assembly.

13. The canister of claim 12, wherein the top cover assembly fits at least partially within the housing assembly.

14. The canister of claim 12, wherein the top cover assembly is welded to the housing assembly.

15. The canister of claim 12, wherein at least one of the sidewall, the end wall, and the cover have a weakened area relative to the remainder of the respective wall, the weakened area adapted to rupture in response to pressure within the canister exceeding a predetermined threshold level.

16. A method of assembling an oxygen generation cell, the method comprising the acts of:
inserting a briquette into a generator housing;
inserting an ignition material into the housing adjacent the briquette;
assembling a top cover assembly, comprising the acts of:
coupling a thimble housing to a filter housing;
placing a filter into the filter housing; and
securing the filter within the filter housing; and
coupling the assembled top cover assembly to the generator housing.

17. The method of claim 16, further comprising sealing an interface between the top cover assembly and the generator housing.

18. The method of claim 17, wherein the top cover assembly is welded to the generator housing.

19. The method of claim 16, further comprising inserting a first filter into the generator housing prior to inserting the briquette and inserting a second filter into the generator housing after inserting the briquette.

20. The method of claim 16, wherein the act of assembling a top cover assembly further comprises inserting a filter support into the filter housing and securing the filter support within the filter housing.

21. The method of claim 16, wherein the act of assembling a top cover assembly further comprises filling the thimble with a fluid and sealing the fluid within the thimble.

22. The method of claim 16, wherein the act of assembling a top cover assembly further comprises pushing the filter past a detent mechanism while placing the filter into the housing.

23. The method of claim 16, further comprising assembling an thimble subassembly prior to coupling the thimble housing to the filter housing, the thimble subassembly comprising the thimble housing, a plunger within the thimble housing, and a seal positioned adjacent the plunger.

24. The method of claim 16, wherein the act of assembling a top cover assembly further comprises coupling a top seal assembly to the filter housing, the top seal assembly comprising a seal and a seal holder.

25. A method of preventing an uncontrolled explosion of a prematurely ignited oxygen generation cell, the method comprising the acts of:
providing a prematurely ignited oxygen generation cell having an initially sealed canister that prevents materials from entering or leaving the canister;
releasing oxygen from a briquette positioned within the canister in response to the premature ignition;
increasing the pressure within the sealed canister due to oxygen being released; and
rupturing a predetermined portion of the canister in a controlled manner when the pressure within the canister exceeds a predetermined threshold level.

26. The method of claim 25, wherein the predetermined portion of the canister is an intentionally weakened area of the canister wall.

27. The method of claim 25, wherein the weakened area of the canister wall has a smaller wall thickness than the remainder of the wall.

28. An oxygen generator cell having a increased shelf-life, the cell comprising:
a sealed canister having a stainless steel housing sealably welded to a stainless steel cover to prevent materials from entering or leaving canister;
a thimble depending from the cover of the can;
a plunger slidable within the thimble and adapted to confine a fluid between the plunger and the thimble;
a projection depending from the plunger and adapted to pierce the bottom of the thimble when the plunger is depressed to allow the fluid to exit the thimble through the pierced end;
an oxygen generating briquette in the canister; and
ignition material on one end of the briquette adapted to be ignited by fluid received from the pierced thimble.
